(19) United States
(12) Patent Application Publication
(10) Pub. No.: US 2008/0163902 A1
(43) Pub. Date: Jul. 10, 2008

(54) COMPRESSOR CLEANING

(75) Inventor: Rudolf MUELLER, Untersiggenthal (CH)

Correspondence Address: BUCHANAN, INGERSOLL & ROONEY PC, POST OFFICE BOX 1404, ALEXANDRIA, VA, 22313-1404, US

(73) Assignee: ABB TURBO SYSTEMS AG, Baden (CH)

(21) Appl. No.: 12/031,149

(22) Filed: Feb. 14, 2008

Related U.S. Application Data
(63) Continuation of application No. PCT/CH2006/000359, filed on Jul. 7, 2006.

(30) Foreign Application Priority Data
Aug. 17, 2005 (EP) 05405481.2

(51) Int. Cl. B08B 13/00; F01D 25/00

(52) U.S. Cl. 134/115 R; 134/201; 416/146 R

(57) ABSTRACT

Rotor blades and hub of the impeller are cleaned by means of a cleaning fluid jet which is directed along the rotational axis of the impeller onto the impeller. The cleaning fluid jet in this case is directed, or sprayed, towards the impeller by a feed nozzle which is arranged on the axis and oriented in the direction of the impeller along the axis. The feed jet in this case follows the axis and therefore strikes the hub of the impeller in the rotational center of the impeller. This achieves the effect of the cleaning fluid striking the impeller in the rotational center of the impeller. The cleaning fluid flows, therefore, along the hub surface and is carried radially into the radially outer regions by means of centrifugal forces.

### RELATED APPLICATIONS

This application claims priority under 35 U.S.C. §119 to EP Application 05405481.2 filed in Europe on Aug. 17, 2005, and as a continuation application under 35 U.S.C. §120 to PCT/CH2006/000359 filed as an International Application on Jul. 7, 2006, designating the U.S., the entire contents of which are hereby incorporated by reference in their entireties.

### TECHNICAL FIELD

The disclosure refers to the field of cleaning of compressors, especially compressors of exhaust gas turbochargers for internal combustion engines.

### BACKGROUND INFORMATION

It is known that with compressors of exhaust gas turbochargers for internal combustion engines the inducting of polluted air can lead to contaminants, especially on the rotor blades and on the hub of the rapidly rotating impeller. The contaminants cause rough surfaces which within a short time can substantially impair the output of the compressor.

In order to avoid the effects which are mentioned in the introduction, compressors are regularly cleaned. The cleaning is carried out under full load or partial load, depending upon design of the compressor. The impeller is correspondingly rotated at full rotational speed or at reduced rotational speed, and a cleaning fluid is fed to the flow upstream of the impeller.

FIG. 1 shows the two cleaning devices which are most frequently used. For introducing the cleaning fluid into the flow passage, simple hoses or thin pipes are guided into the flow region from radially outside the compressor casing or else in the region of a casing center piece in the radially inner region of the flow passage. The required amount of cleaning fluid can be injected through these hoses or pipes for cleaning the impeller at the appropriate point in time. The cleaning fluid is carried away by the flow and transported into the region of the rotor blades of the rotating impeller. Due to the high rotational speed of the impeller, the cleaning fluid is centrifuged predominantly into the radially outer region of the rotor blade surfaces. The water jet, moreover, for kinematic reasons (ratio of the speed of the compressor rotor blades to the speed of the water jet) cannot penetrate sufficiently deeply between the rotor blades. Particularly in the case of the variants with the radially outer lying cleaning fluid feed line, it happens that radially inner regions of the rotor blade and the hub surface between the rotor blades cannot be reached by the cleaning fluid and so the cleaning effect is unsatisfactory.

If these regions, which cannot be reached in the case of the rapidly rotating impeller, are to be effectively cleaned, the internal combustion engine has to be throttled in order to lower the rotational speed of the impeller and consequently to lower the speed of the compressor rotor blades.

Cleaning with conventional cleaning devices, therefore, does not always lead to satisfactory results.

DE 299 09 629 U1 discloses a compressor with a device for introducing a solution for preventing deposits in the compressor. The solution in this case is atomized via a nozzle just upstream of the compressor or in the compressor. Engine oil, which is extracted from the lubricating oil circuit of the internal combustion engine, is provided as solution.

### SUMMARY

A compressor with an improved cleaning device is disclosed, by which the compressor can be effectively freed of contaminants even with a rapidly rotating impeller.

A compressor is disclosed, comprising an impeller which is rotatable around an axis, and also a cleaning device for cleaning the impeller, with a feed line for a cleaning fluid, wherein the feed line for the cleaning fluid comprises a feed nozzle which is arranged on the axis and oriented in the direction of the axis in such a way that the cleaning fluid can be directed through the feed nozzle as a bunched feed jet along the axis towards the impeller.

An impeller is disclosed, comprising a hub and rotor blades which are arranged on the hub, wherein means for receiving and transmitting a cleaning fluid which is guided as a bunched feed jet along the axis onto the impeller, are let into the hub.

A cylindrical impeller cleaning attachment is disclosed, comprising a central opening into which a cleaning fluid, which is guided as a bunched feed jet along the axis onto the impeller cleaning attachment, can be guided, and which in its radially outer region leads into radially outwards oriented cleaning nozzles, via which the fluid which is directed into the central opening can be directed radially from the cleaning attachment.

### BRIEF DESCRIPTION OF THE DRAWINGS

The compressor according to the disclosure with a cleaning device is subsequently explained in more detail with reference to drawings. In the drawings in this case

FIG. 1 shows a section, directed along the axis, through a compressor with a cleaning device,

FIG. 2 shows a section, directed along the axis, through a compressor according to the disclosure with a first exemplary embodiment of the cleaning device,

FIG. 3 shows a section, directed along the axis, through a compressor according to the disclosure with a second exemplary embodiment of the cleaning device,

FIG. 4 shows a section, directed along the axis, through a compressor according to the disclosure with a third exemplary embodiment of the cleaning device, with a cleaning attachment with a plurality of cleaning nozzles,

FIG. 5 shows a section through the cleaning attachment in accordance with FIG. 4, and

FIGS. 6 and 7 respectively show a section through two differently formed cleaning nozzles of the cleaning attachment in accordance with FIG. 5.

### DETAILED DESCRIPTION

According to the disclosure, rotor blades and hub of the impeller are cleaned by means of a cleaning fluid jet which is directed along the rotational axis of the impeller onto the impeller. The cleaning fluid jet in this case is directed or sprayed towards the impeller from a feed nozzle which is arranged upon the axis and oriented in the direction of the impeller along the axis. The feed jet in this case follows the axis and consequently strikes the hub of the impeller in the rotational center of the impeller.

This achieves the effect of the cleaning fluid striking the impeller in the radially innermost point, that is in the rotational center, of the impeller. Even if the cleaning fluid is then gathered by the strong flow and is carried radially outwards, it is ensured that the cleaning fluid at least partially flows along the hub surface and the desired cleaning of the surface occurs in the process.

By a jet divider in the rotational center of the impeller the feed jet can be uniformly divided and deflected in the radial direction. The jet divider has a tip and advantageously has inclined flanks which are curved radially outwards. As a result, the feed jet can be smoothly deflected so that it does not spray back from the hub surface.

The feed jet can additionally be collected by a central bore in the rotational center of the impeller. Especially in combination with the jet divider, an optimum intermediate storage for the cleaning fluid is created in this way. In the central bore, the cleaning fluid is carried radially outwards and accelerated in the circumferential direction. In the radial extension of the central bore, a ring of cleaning fluid is formed, which co-rotates with the impeller. The cleaning fluid is consequently uniformly distributed along the circumference of the central bore, so that the cleaning fluid which issues from the central bore can also uniformly clean the impeller along the circumference.

For specific orientation of the cleaning fluid onto the rotor blades of the impeller, or onto hub regions which lie between the rotor blades, radially outwards oriented cleaning nozzles can be let into the hub of the impeller. The cleaning nozzles are especially advantageously arranged in the radially outer region of the central bore so that the cleaning fluid can be forced from the central bore through the cleaning nozzles as a result of the centrifugal acceleration and directed onto the regions of the impeller which are to be cleaned.

Depending upon requirement, the cleaning nozzles are oriented so that the jet which is produced issues from the nozzle in a bunched or diverging manner. A diverging jet is advantageous if a distribution of cleaning fluid over a large area is aimed for, while the bunched jet is typically directed onto surface points with persistent contamination.

The jet divider, the central bore and the cleaning nozzles can be integrated individually or in any combination in a cleaning attachment which can be fitted onto the hub tip of the impeller and fastened thereupon. As a result, existing impellers can be retrofitted with the cleaning device according to the disclosure in the conceivably simplest way.

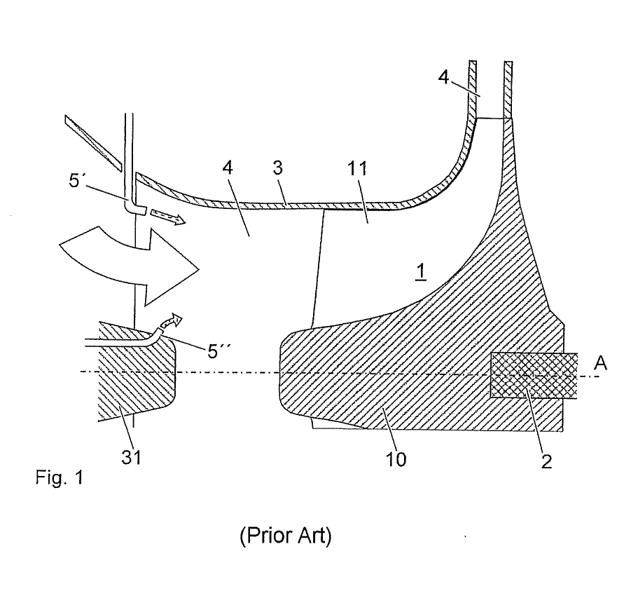

As already mentioned in the introduction, FIG. 1 shows a compressor arrangement with a conventional cleaning device. For introducing the cleaning fluid into the flow passage 4, feed lines 5′ or 5″ in the form of simple hoses or thin pipes are guided into the flow region from radially outside the compressor casing 3, or, in an alternative embodiment as is used by certain compressor manufacturers, in the region of a casing center piece 31 in the radially inner region of the flow passage. The required amount of cleaning fluid can be injected through these feed lines into the flow passage for cleaning the impeller 1 at the appropriate point in time. During operation, the cleaning fluid is gathered by the flow and transported into the region of the rotor blades of the rotating impeller.

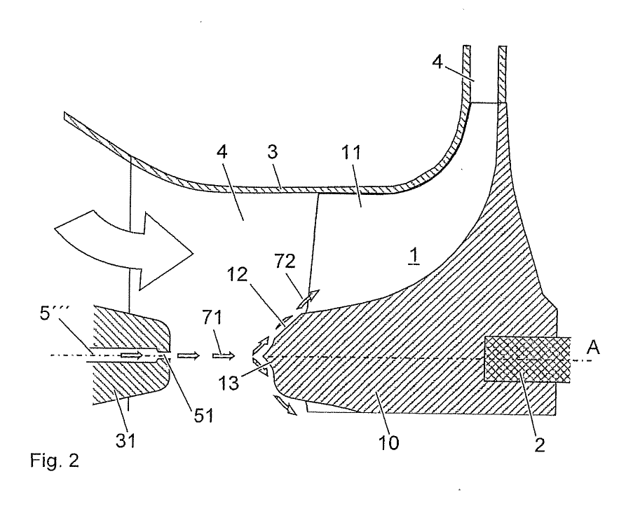

Unlike the conventional cleaning device, in the case of the compressor cleaning according to the disclosure the feed line 5′″ for the cleaning fluid is centrally arranged. As shown in FIG. 2, the feed nozzle 51, through which the cleaning jet is injected into the region of the impeller as a single bunched jet without atomizing angle, which extends parallel to the axis, is arranged coaxially to and in the direction of the axis A of the impeller 1. The feed nozzle for example is arranged in a casing center piece 31, but can also be fastened in the center from radially outside the compressor casing by means of a passage through the intake region of the compressor.

Seen from the fluidic point of view, the feed jet 71 in the case of a radial compressor lies upon a flow line which is directed along the axis. As a result, even during full load operation of the compressor and with correspondingly stronger flow, the cleaning fluid can be injected in a manner in which it is directed with greater precision onto the impeller. Although the feed jet 71 of cleaning fluid occurs in the center of the impeller, the cleaning fluid is carried along the hub surface and the rotor blade roots as a result of the large centrifugal forces into the outer regions of the impeller, especially of the rotor blades 11, so that a complete wetting of the impeller is carried out.

The feed jet strikes the nose of the hub 10 of the impeller 1 and is deflected there from the axial direction into the radial direction. In order to assist the deflection and to ensure the uniform distribution of cleaning fluid, in the first exemplary embodiment of the compressor cleaning according to the disclosure in accordance with FIG. 2, the nose of the hub of the impeller is formed into a flow divider 13. The flow divider is basically an axially oriented point with radially outwards inclined flanks. The flanks in this case can be formed continuously or else divided into individual triangular segments.

In order to direct the cleaning fluid flow, which is deflected in the radial direction, specifically onto individual regions of the surfaces which are to be cleaned, cleaning nozzles 12 in the form of holes or slot-shaped recesses can be let into the surface of the hub radially outside the center of the hub. A constant cleaning nozzle jet 72 can be directed through the cleaning nozzles onto the same point of the impeller, since the nozzles of course do not move relative to the points which are to be cleaned.

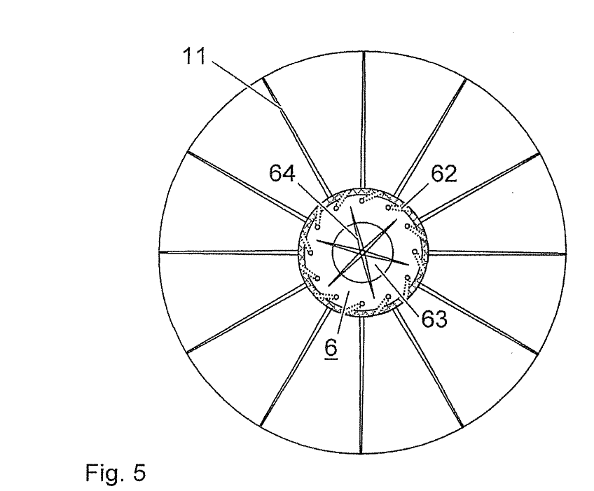

A washing nozzle per rotor blade is advantageously arranged, as is also schematically indicated in the sectional diagram in accordance with FIG. 5.

It is also conceivable that cleaning nozzles are arranged in a differently oriented manner along the circumference, so that for example one row of first nozzles is directed onto the rotor blades, and second nozzles, which are arranged between the nozzles of the first row in each case, are oriented onto the regions of the surface of the hub which are to cleaned.

So that the cleaning fluid film which is formed on the surface of the nose of the hub penetrates into the nozzles, no projections, which block the flow of cleaning fluid in the radial direction, can be attached radially outside the nozzles. Alternatively, an encompassing annular projection can be provided, which accumulates the cleaning fluid all around.

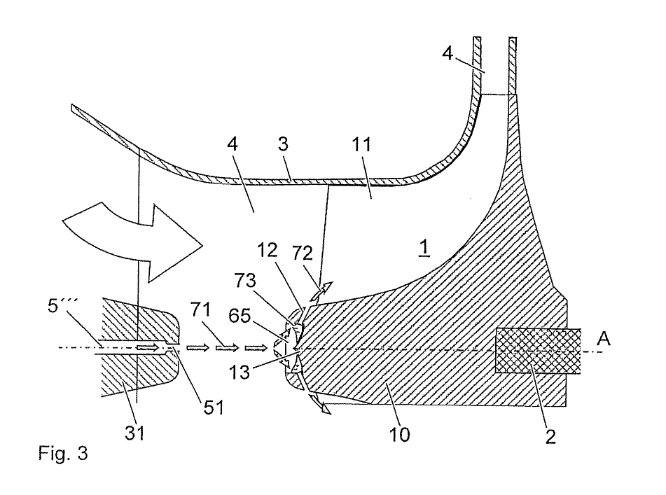

In order to be able to even better gather the cleaning fluid during the radial deflection of the feed jet 71, a central opening 15 is let into the nose of the hub 10 according to the second exemplary embodiment of the compressor cleaning according to the disclosure in accordance with FIG. 3. The feed jet 72, after the deflection, is retained inside the central opening 15, so that an encompassing ring 73 of cleaning fluid is formed on the radial outer wall of the central opening. In this way, little is lost from the cleaning fluid which is sprayed at high pressure onto the hub of the impeller, possible radially directed sprays are held back by the radial outer wall of the central opening. Due to the accumulation of cleaning fluid on the radial outer wall of the central opening, a pressure increase in the cleaning fluid results. The cleaning fluid issues either by means of overflow from the central opening, or through cleaning nozzles 12 which are let into the radial outer region of the central opening.

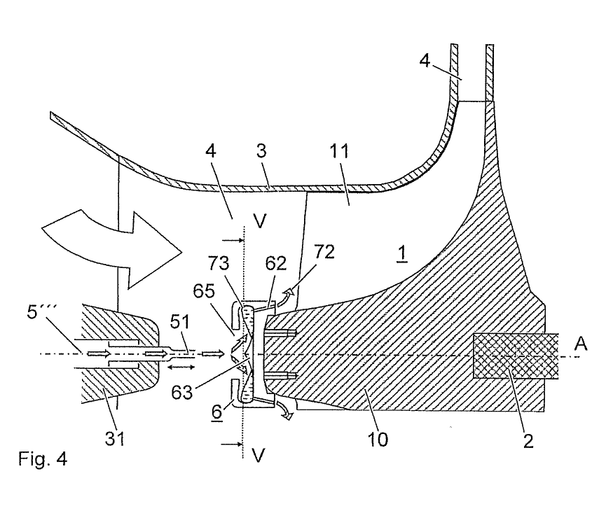

In a third exemplary embodiment of the compressor cleaning according to the disclosure in accordance with FIG. 4, central opening 65, flow divider 63 and cleaning nozzles 62 are integrated in a separate component, that is the cleaning attachment 6. The cleaning attachment can be fitted onto the hub and connected to the hub by screws or other fastening means. In this way, compressors without cleaning device or compressors with conventional cleaning devices can be retrofitted.

When the feed jet strikes the surface of the hub or of the cleaning attachment, and also during the deflection in the radial direction, the cleaning fluid is accelerated in the circumferential direction. In order to assist this acceleration, as shown in the section through the cleaning attachment in FIG. 5, guide vanes 64 can be provided, which in the manner of a propeller accelerate the deflected feed jet.

In the section through the cleaning attachment 6, the cleaning nozzles 62 are also to be seen, which in the represented embodiment are not strictly radially outwards let into the wall of the cleaning attachment, but, corresponding to the rotational direction of the impeller, are let in a manner extending obliquely to the radial.

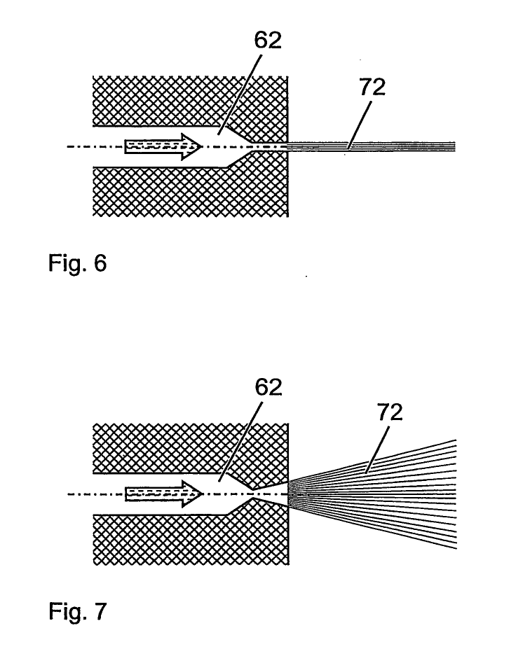

The cleaning nozzles can be correspondingly oriented to the region of the impeller which is to be cleaned. Depending upon whether all the rotor blades 11, or a defined section of the surface of the hub, which is subjected to especially heavy contamination, are to be cleaned, differently oriented and differently formed nozzles can be advisable. The cleaning nozzle jet 72 can ultimately be influenced by the development of the orifices of the cleaning nozzles. As shown in the last two figures, the jet can leave the nozzles in a bunched (FIG. 6) or in a diverging (FIG. 7) manner.

The amount of cleaning fluid which issues through the cleaning nozzles is advantageously added to the amount of cleaning fluid which is fed to the impeller by means of the feed jet through the feed nozzle. The added amount in this case should be slightly greater in order to compensate possible losses through sprays. In order to prevent such losses and to reduce the influence of the feed jet by the flow of the medium which is to be compressed, the feed nozzle 51 can reach up to a short distance of several mm to several cm, depending upon dimensions of the impeller, to the nose of the hub of the impeller. Alternatively, the feed nozzle, as schematically indicated in FIG. 4, can be formed with retracting and extending capability. As a result, the feed nozzle can be extended into the flow zone for cleaning, whereas no impairment of the flow occurs thanks to a retracted nozzle.

As cleaning fluid, for example water, with or without special processing, purification or temperature conditioning, with or without cleaning additives, can be used.

The compressor cleaning according to the disclosure is especially suitable for cleaning radial compressors of exhaust gas turbochargers for internal combustion engines.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

A Axis
1 Impeller
10 Hub
11 Rotor blades
12 Cleaning nozzles
13 Jet divider
15 Central opening
2 Shaft
3 Compressor casing
31 Casing center piece
4 Flow passage
5 Feed line for cleaning fluid
5′ Outer feed line
5″ Inner feed line
5′″Coaxial feed line
51 Feed nozzle
6 Cleaning attachment
62 Cleaning nozzles
63 Jet divider
64 Guide vanes for cleaning fluid
65 Central opening
71 Feed jet
72 Cleaning nozzle jet
73 Cleaning fluid ring

What is claimed is:

1. A compressor, comprising an impeller which is rotatable around an axis, and also a cleaning device for cleaning the impeller, with a feed line for a cleaning fluid, wherein the feed line for the cleaning fluid comprises a feed nozzle which is arranged on the axis and oriented in the direction of the axis in such a way that the cleaning fluid can be directed through the feed nozzle as a bunched feed jet along the axis towards the impeller.

2. The compressor as claimed in claim 1, wherein means for dividing the feed jet are provided, by which the feed jet can be deflected in the radial direction.

3. The compressor as claimed in claim 1, wherein the impeller has a central opening for receiving the feed jet and for transmitting the cleaning fluid.

4. The compressor as claimed in claim 1, wherein a cleaning attachment is fastened on the impeller, and that the cleaning attachment has a central opening for receiving the feed jet and for transmitting the cleaning fluid.

5. The compressor as claimed in claim 3, wherein the central opening in its radially outer region leads into cleaning nozzles, via which the cleaning fluid, which is directed by the feed jet towards the impeller, can be directed onto regions of the impeller which are to be cleaned.

6. The compressor as claimed in claim 1, wherein the impeller comprises cleaning nozzles, via which the cleaning fluid, which is directed by the feed jet towards the impeller, can be directed onto regions of the impeller which are to be cleaned.

7. The compressor as claimed in claim 5, wherein the cleaning nozzles are formed in such a way that the cleaning fluid leaves the nozzle as a bunched jet.

8. The compressor as claimed in claim 5, wherein the cleaning nozzles are formed in such a way that the cleaning fluid leaves the nozzle as a diverging jet.

9. The compressor as claimed in claim 1, wherein the impeller comprises guide vanes, by which the cleaning fluid, which is directed by the feed jet towards the impeller, can be accelerated in the circumferential direction.

10. The compressor as claimed in claim 1, wherein the feed nozzle is formed with displacement capability in the axial direction to the impeller, so that for directing the feed jet onto the impeller the distance between the feed nozzle and the impeller, which is to be bridged by means of the feed jet, can be reduced.

11. An impeller, comprising a hub and rotor blades which are arranged on the hub, wherein means for receiving and transmitting a cleaning fluid which is guided as a bunched feed jet along the axis onto the impeller, are let into the hub.

12. The impeller as claimed in claim 11, wherein a central opening is let into the hub, into which a cleaning fluid can be directed and which in its radially outer region leads into cleaning nozzles, via which the cleaning fluid, which is directed into the central opening, can be directed onto regions of the hub and/or of the rotor blades which are to be cleaned.

13. A cylindrical impeller cleaning attachment, comprising a central opening into which a cleaning fluid, which is guided as a bunched feed jet along the axis onto the impeller cleaning attachment, can be guided, and which in its radially outer region leads into radially outwards oriented cleaning nozzles, via which the fluid which is directed into the central opening can be directed radially from the cleaning attachment.

14. An exhaust gas turbocharger, characterized by a compressor as claimed in claim 1.

15. The compressor as claimed in claim 2, wherein the impeller has a central opening for receiving the feed jet and for transmitting the cleaning fluid.

16. The compressor as claimed in claim 3, wherein a cleaning attachment is fastened on the impeller, and that the cleaning attachment has a central opening for receiving the feed jet and for transmitting the cleaning fluid.

17. The compressor as claimed in claim 4, wherein the central opening in its radially outer region leads into cleaning nozzles, via which the cleaning fluid, which is directed by the feed jet towards the impeller, can be directed onto regions of the impeller which are to be cleaned.

18. The compressor as claimed in claim 4, wherein the impeller comprises cleaning nozzles, via which the cleaning fluid, which is directed by the feed jet towards the impeller, can be directed onto regions of the impeller which are to be cleaned.

19. The compressor as claimed in claim 6, wherein the cleaning nozzles are formed in such a way that the cleaning fluid leaves the nozzle as a bunched jet.

20. The compressor as claimed in claim 6, wherein the cleaning nozzles are formed in such a way that the cleaning fluid leaves the nozzle as a diverging jet.

21. The compressor as claimed in claim 8, wherein the impeller comprises guide vanes, by which the cleaning fluid, which is directed by the feed jet towards the impeller, can be accelerated in the circumferential direction.

22. The compressor as claimed in claim 9, wherein the feed nozzle is formed with displacement capability in the axial direction to the impeller, so that for directing the feed jet onto the impeller the distance between the feed nozzle and the impeller, which is to be bridged by means of the feed jet, can be reduced.

23. An exhaust gas turbocharger, characterized by a compressor as claimed in claim 10.
